(19) United States
(12) Patent Application Publication
(10) Pub. No.: US 2019/0315653 A1
(43) Pub. Date: Oct. 17, 2019

(54) DIMPLED GLASS BUMPS ON GLASS ARTICLES AND METHODS OF FORMING THE SAME

(71) Applicant: CORNING INCORPORATED, CORNING, NY (US)

(72) Inventors: David Mark Lance, Elmira, NY (US); Alexander Mikhailovich Streltsov, Corning, NY (US)

(21) Appl. No.: 16/343,145

(22) PCT Filed: Oct. 20, 2017
(86) PCT No.: PCT/US17/57550

§ 371 Date: Apr. 18, 2019

Related U.S. Application Data
(60) Provisional application No. 62/410,466, filed on Oct. 20, 2016.

(51) Int. Cl. C03C 23/00

(52) U.S. Cl. CPC C03C 23/0025; C03C 2204/08; C03C 2203/52

(57) ABSTRACT

A glass article having a dimpled glass bump formed integrally thereon by laser-irradiation methods. The glass bump includes a lower region connected to an upper region by an inflection region. The lower region projects from a surface of the glass article and is defined by concavely rounded sides with a radius of curvature R1. The upper region includes a transition portion and a top surface. The transition portion is defined by convexly rounded sides with a radius of curvature R2. The transition portion connects to the lower portion via the inflection region. The upper portion connects to the transition portion and is defined by a concavely rounded top portion between convexly rounded top portions.

This application claims the benefit of priority of U.S. Provisional Application Ser. No. 62/410,466, filed Oct. 20, 2016, the contents of which are relied upon and incorporated herein by reference in their entirety as if fully set forth below.

### BACKGROUND

The present disclosure relates to a dimpled glass bump formed on a glass article and methods of laser-irradiating the glass article to form the same.

### SUMMARY

According to one embodiment of the present disclosure, a glass article including a dimpled glass bump thereon is disclosed. In embodiments, the dimpled glass bump includes a lower region and an upper region connected by an inflection region. In embodiments, the lower region includes a diameter D1 defined by concavely rounded sides including a radius of curvature R1 that join with the glass article surface. In embodiments, the lower region projects from the surface of the glass article. In embodiments, the upper region includes a transition portion and a top surface. In embodiments, the transition portion includes a diameter D2 defined by convexly rounded sides having a radius of curvature R2. In embodiments, the top surface includes a diameter D3 defined by a concavely rounded top portion between convexly rounded top portions. In embodiments, the convexly rounded top portions join with the convexly rounded sides converging from the transition portion. In embodiments, the convexly rounded top portions are spaced apart from the glass article surface defining a height H of the glass bump.

According to another embodiment of the present disclosure, a method of making an article having a dimpled glass bump thereon is disclosed. In embodiments, the method includes irradiating the article with laser radiation to locally heat and induce growth of a precursor glass bump from the glass pane. In embodiments, the method includes pausing irradiation of the glass article for a time. In embodiments, the method includes irradiating the precursor glass bump with laser radiation to form the dimpled glass bump.

Before turning to the following Detailed Description and Figures, which illustrate exemplary embodiments in detail, it should be understood that the present inventive technology is not limited to the details or methodology set forth in the Detailed Description or illustrated in the Figures. For example, as will be understood by those of ordinary skill in the art, features and attributes associated with embodiments shown in one of the Figures or described in the text relating to one of the embodiments may well be applied to other embodiments shown in another of the Figures or described elsewhere in the text.

### BRIEF DESCRIPTION OF THE FIGURES

The disclosure will be better understood, and features, aspects and advantages other than those set forth above will become apparent when consideration is given to the following detailed description thereof. Such detailed description makes reference to the following drawings, wherein:

FIG. 1 is a close-up cross-sectional view of a dimpled glass bump according example embodiments.

FIG. 2 is a cross-sectional view of a precursor glass bump at an intermediary stage in the laser-irradiation growth process according to embodiments.

FIG. 3 is a schematic diagram of an example laser-based glass bump forming apparatus used to form dimpled glass bumps on a glass article according to embodiments.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the exemplary methods and materials are described below.

A glass article of the present disclosure includes a surface and can have any shape. In one example, the glass article can be round, spherical, curved, or flat. In another example the glass article can be relatively thick (about 10 cm) or relatively thin (about 0.1 millimeters). In yet another example, the glass article has a thickness between about 0.5 millimeters and about 3 millimeters (e.g., 0.5, 0.7, 1, 1.5, 2, 2.5, or 3 millimeters). In one embodiment, the glass article is comprised of a plurality of individual glass components joined or fused together (e.g., multiple glass articles joined or fused together into a larger glass article). In an exemplary embodiment, the glass article is a glass pane 20 including top and bottom surfaces and an outer edge. Glass pane 20 of the present disclosure may be substantially flat across its surfaces and may have any shape. The glass article of the present disclosure may be formed from soda-lime glass, borosilicate glass, aluminosilicate glass, alkali aluminosilicate glass, or combinations thereof.

The glass article of the present disclosure comprises at least one of dimpled glass bump 10. In embodiments, the glass article includes a plurality of dimpled glass bumps 10. In one embodiment, the dimpled glass bumps 10 are grown from the surface of the glass article by absorption of laser-irradiation. In embodiments, the dimpled glass bump 10 is grown on a surface of a glass article by repeated laser irradiation of the same location on the glass article. The dimpled glass bump 10 of the present disclosure may be used as a spacer between parallel, opposing panes of glass in a vacuum-insulated glass (VIG) window. In a VIG window, the dimpled glass bump 10 may assist in maintaining the distance between the opposing glass panes that have a tendency to bow together under the force of vacuum pressure there between and external atmospheric pressure and external forces (e.g., weather). In embodiments, the distance between the parallel, opposing panes of glass in VIG window is substantially equivalent to the height of the dimpled glass bump 10. The dimpled glass bumps 10 of the present disclosure are configured to minimize heat transfer through the window and reduce stress on individual dimpled glass bumps 10 and correspondingly on the opposing glass pane contacting the dimpled glass bumps 10.

Dimpled glass bumps 10 may be grown out of a body of the glass article and formed from the glass material making up the glass article, so as to outwardly protrude in a convex manner. Dimpled glass bumps 10 are comprised of the same glass composition as the glass article. In one embodiment, the glass article is comprised of a plurality of individual glass components, each glass component including at least one locality L and/or at least one dimpled glass bump 10. The plurality of dimpled glass bumps 10 may include any number of glass bumps including as few as 20, 15, 10, 5, or 1 glass bump. In an example embodiment, dimpled glass bumps 10 are regularly spaced apart on the glass article with respect to each other. Distances between the dimpled glass bumps 10 may be from about 1 mm (about 1/25 of an inch) to about 25 centimeters (about 10 inches), or from about 1 centimeter (about 0.4 inches) to about 15 centimeters (about 6 inches) or more. Spacing the dimpled glass bumps 10 closer together reduces stress concentration on individual bumps in a VIG window. In another embodiment, the dimpled glass bumps 10 are irregularly or randomly spaced apart on the glass article with respect to each other.

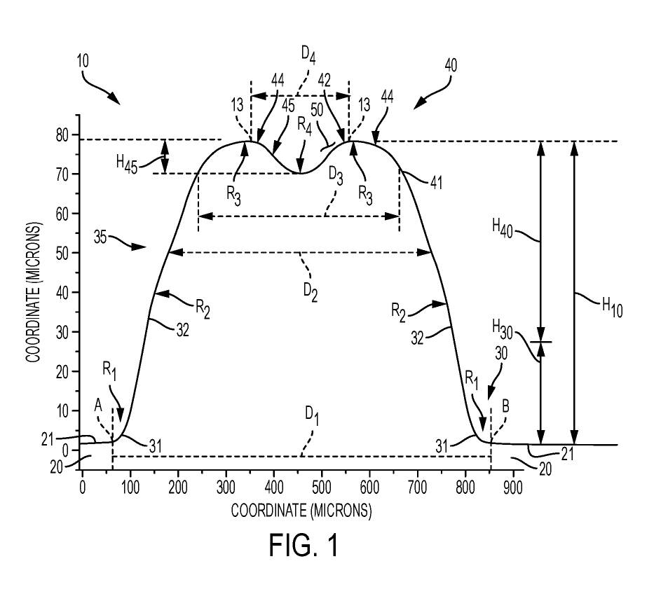

Referring to FIG. 1, an example close-up cross-sectional view of an example dimpled glass bump 10 on a glass pane 20 is shown with a coordinate grid for reference. The dimpled glass bump 10 includes a lower region 30 and an upper region 40 connected by an inflection region 35. The dimpled glass bump 10 has a height H10 measured from a back surface 21 of glass pane 20 to a terminal point or points 13. While embodiments herein describe forming the dimpled glass bump 10 on the back surface 21 of the glass pane 20, it should be understood that the dimpled glass bumps 10 may be formed an any surface of the glass pane 20.

Referring still to FIG. 1, the terminal point 13 is a location or locations on the dimpled glass bump 10 at the furthest distance from the back surface 21 of glass pane 20. In one embodiment, the terminal point 13 may be an area on the dimpled glass bump 10. For example, the terminal point 13 may be a circular area or a toroidal area. Height H10 of the dimpled glass bump 10 may range from 20 microns to 200 microns, or from 75 microns to 150 microns, or even from 100 microns to 120 micron, including all ranges and subranges there between. Note that if bump heights H10 are too small, the gap between opposing plates in a VIG window is reduced and, therefrom, a reduced vacuum space between opposing panes and reduced insulating properties. In addition, small heights H10 (e.g., <50 microns) of the dimpled glass bump 10 can lead to the appearance of optical rings due to light interference between closely arranged glass surfaces. The example dimpled glass bump 10 depicted in FIG. 1 has a height H10 of about 78 microns and a diameter D1 of about 808 microns.

As depicted in FIG. 1, the lower region 30 of the dimpled glass bump 10 projects from the back surface 21 of the glass pane 20 and is integrally formed thereon. Lower region 30 has a height H30 that may extend from about 5% to about 35% of the height H10 of the dimpled glass bump 10. The lower region 30 includes a diameter D1 defined by concavely rounded sides 31. The diameter D1 is the distance between the points A and B where the concavely rounded sides 31 terminate and join with the back surface 21 of the glass pane 20. Diameter D1 may be from about 600 microns to about 900 microns, or even about 700 microns to about 850 microns. A dimpled glass bump 10 with a diameter D1 that is smaller than 600 microns may have a top surface with smaller radii of curvature, which causes increased stress concentration on opposing glass panes in a VIG window. Further, dimpled glass bumps 10 with diameter D1 larger than 900 microns may be visible when used between glass panes in a VIG window.

The concavely rounded sides 31 of lower region 30 include a radius of curvature R1, which may be from about 30 microns to about 150 microns, such as from about 60 microns to about 120 microns. Radius of curvature R1 may vary slightly within the disclosed range at different locations around the dimpled glass bump 10. Further, the radius of curvature R1 is configured such that the dimpled glass bump 10 projects from the back surface 21 so as not to exceed the disclosed range for diameter D1 and to maintain top diameter D3 as disclosed herein.

Referring still to FIG. 1, the inflection region 35 of the dimpled glass bump 10 connects the lower region 30 and the upper region 40. In embodiments, the upper region 40 includes a transition portion 41 and a top surface 42. Further, the upper region 40 has a height H40 that may extend from about 65% to about 95% of the height H10 of the dimpled glass bump 10.

The transition portion 41 of upper region 40 includes a diameter D2 defined by convexly rounded sides 32. Diameter D2 may extend from about 33% to about 85% of diameter D1 of the dimpled glass bump 10. The convexly rounded sides 32 join with the concavely rounded sides 31 extending up from lower region 30 at inflection region 35. Convexly rounded sides 32 have a convex radius of curvature R2, which may be from about 1000 microns to about 5000 microns, or about 2000 microns to about 3500 microns, and may vary slightly within the disclosed range at different locations around the dimpled glass bump 10. The convex radius of curvature R2 may be measured over at least 5 microns or 5% of the height H10 of the dimpled glass bump 10. Alternatively, the convex radius of curvature R2 may be measured over 50% of the height H10 of the dimpled glass bump. Diameter D2, which is measured between the convexly rounded sides 32, may be from about 300 microns to about 700 microns. Diameter D2 of the transition portion 41 decreases by about 10% to about 65% from the inflection region 35 to the top surface 42. Further, the diameter D2 is less than the diameter D1 since the diameter of the dimpled glass bump 10 gradually decreases from the lower region 30 to the transition portion 41.

The top surface 42 includes a diameter D3 and is defined by a concavely rounded top portion 45 between convexly rounded top portions 44. Convexly rounded top portions 44 are spaced apart from the back surface 21 and define the height H10 of the dimpled glass bump 10 as each convexly rounded top portion 44 includes a terminal point 13. The convexly rounded top portions 44 may extend from about 1% to about 10% of the height H10 of the dimpled glass bump 10. In embodiments, the diameter D3 may extend from about 15% to about 35% of the diameter D1, or about 20% to about 33% of the diameter D1. Further, the convexly rounded top portions 44 join with convexly rounded sides 32 converging from transition portion 41. The convexly rounded top portions 44 each have a convex radius of curvature R3 of from about 300 microns to about 1600 microns, or about 500 microns to about 1200 microns.

Referring still to FIG. 1, the concavely rounded top portion 45 is located between the convexly rounded top portions 44 thereby defining the diameter D3. The concavely rounded top portion 45 includes a radius of curvature R4 of from about 200 microns to about 2000 microns, or from about 300 microns to about 1000 microns. In embodiments, a volume 50 is formed adjacent to the concavely rounded top portion 45 and between the convexly rounded top portions 44. Volume 50 is the dimple of the dimpled glass bump 10. Volume 50 may be a void volume devoid of glass or other material. Volume 50 is also referred to herein as a “dimple” on the dimpled glass bump 10. In embodiments, the volume 50 may be defined by a height H45 between concavely rounded top portion 45 and the terminal points 13 located on the convexly rounded top portions 44. In embodiments, the height H45 is from about 1 micron to about 50 microns, or from about 5 microns to about 15 microns, or even from about 7 microns to about 12 microns. In embodiments, the volume 50 may also be defined by a distance D4 extending between the terminal points 13 of the convexly rounded top portions 44. In embodiments, the distance D4 is from about 100 microns to about 300 microns, or from about 150 microns to about 250 microns. In embodiments, the distance D4 may extend from about 10% to about 50% of diameter D1, or about 20% to about 40% of diameter D1. In embodiments, volume 50 may be defined by both height H45 and distance D4. Further, distance D4 of the example dimpled glass bump 10 in FIG. 1 is about 210 microns and the height H45 of the example dimpled glass bump 10 in FIG. 1 is about 10 microns.

In embodiments, the volume 50 may contain a friction reduction material. In embodiments, the friction reduction material may be a liquid, a powder, a solid, and combinations thereof. In embodiments, friction reduction material may an organic material, an inorganic material, or a combination thereof. In embodiments, the friction reduction material includes tungsten disulfide, molybdenum disulfide, tungsten diselanide, molybdenum diselanide, or combinations thereof. In embodiments, the friction reduction material is configured to reduce the coefficient of friction between the top surface 42 of the dimpled glass bump 10 and the surface of another opposing glass pane contacting the top surface 42 of the dimpled glass bump 10. In embodiments, friction reduction material reduces the coefficient of friction between the top surface 42 of the dimpled glass bump 10 and an opposing glass pane by about 5% to about 100%. In embodiments, the volume 50 is configured to retain the friction reduction material therein and act as a reservoir for the friction reduction material. An opposing surface (e.g., of a glass pane) contacting the top surface 42 of the dimpled glass bump 10 may assist in retaining the friction reduction material within the volume 50.

Furthermore, the radius of curvature R3 of the convexly rounded top portions 44 is configured such that contact between opposing glass panes in a VIG window minimizes stress on individual dimpled glass bumps 10 and the opposing glass pane(s), and minimizes contact heat transfer between the opposing panes through the dimpled glass bumps 10. The radius of curvature R3 may be any radius of curvature that can be formed by a laser irradiation process of the present disclosure without the use of a growth-limiting structure. Thus, the laser-irradiation process and methods of growing the dimpled glass bump 10 of the present disclosure, which do not use a growth-limiting structure to form the concavely rounded top portion 45 between convexly rounded top portions 44, present significant time savings for growing the dimpled glass bumps 10 when compared to conventional methods. Specifically, the need to align the glass article relative to the growth-limiting structure before growing the dimpled glass bump 10 via laser-irradiation is eliminated.

In an exemplary embodiment, the convex radius of curvature R3 is smaller than the convex radius of curvature R2. In another embodiment, the convex radius of curvature R2 is greater than the convex radius of curvature R3 by about 80% to about 500%, or about 100% to about 350%. In yet another embodiment, the convex radius of curvature R3 is greater than the concave radius of curvature R1. Diameter D3, measured between the transition portion 41 on opposite sides of the dimpled glass bump 10, is less than diameter D2. Further, diameter D3, at its maximum, may be from about 200 microns to about 600 microns, and may decreases incrementally towards the opposite terminal points 13 of the convexly rounded top portions 44. Moreover, the diameter D3 is greater than distance D4.

Referring still to FIG. 1, the transition portion 41 and the top surface 42 are integrally formed together. Further, the inflection region 35 connects the lower region 30 and the upper region 40 at the transition portion 41. The inflection region 35 may be defined by sides without a radius of curvature (i.e., flat or perpendicular to the back surface 21). In one embodiment, the inflection region 35 is a 2-dimensional area (e.g., a plane). In another embodiment, inflection region 35 extends about 5% or less of the height H10 of the dimpled glass bump 10.

The dimpled glass bump 10 as described above and according to the present disclosure is different than conventional glass bumps grown according to conventional methods. In embodiments, the dimpled glass bump 10 includes a top surface 42 that has a concavely rounded top portion 45 between the convexly rounded top portions 44. In embodiments the dimpled glass bump 10 includes convexly rounded sides 32 with radii of curvature R2 greater than the convexly rounded top portions 44 radii of curvature R3 and/or R4. That is, the radius of curvature for the sides of the dimpled glass bump 10 extending up from the glass article surface (e.g., extending up from the back surface 21) is greater than the radii of curvature along the top surface 42. Convexly rounded top portions 44 with radii of curvature R3 smaller than convexly rounded sides 32 may optimize contact between the dimpled glass bump 10 and an opposing glass pane. That is, as the pressure increases between opposing panes in a VIG window (thereby transferring that force onto the dimpled glass bumps 10) the opposing glass pane may deform slightly and contact a greater area of the top surface 42 of the dimpled glass bump 10 (e.g., 3-5% of the height H10 of the dimpled glass bump 10). Likewise, when pressure decreases between opposing panes in a VIG window, the opposing glass pane contacts a smaller area on the top surface 42 of the dimpled glass bump 10 (e.g., 1-2% of the height H10 of the dimpled glass bump 10). Accordingly, the radius of curvature along the top surface 42 of the dimpled glass bump 10 of the present disclosure provides benefits as compared to conventional glass bumps. Further, the dimple of the dimpled glass bump 10 may allow for retaining material (e.g., friction reducing material) in certain applications.

Dimpled glass bumps 10 may act as spacers between the glass article and other materials. In yet another example, dimpled glass bumps 10 may have aesthetic advantages. Conventional glass bumps with a top surface radius of curvature greater than about 300 microns have a large area of contact with opposing panes in a VIG window enabling and creating a larger heat transfer area. Conventional glass bumps with a top surface radius of curvature less than about 300 microns have a small area of contact with opposing panes in a VIG window which may cause stress at the small contact area on the opposing pane and can lead to surface defects.

In one embodiment of the present disclosure, the dimpled glass bumps 10 are formed by photo-induced absorption. Photo-induced absorption includes a local change of the absorption spectrum of a glass article resulting from locally exposing (irradiating), or heating, the glass article with radiation (i.e., laser irradiation). Photo-induced absorption may involve a change in adsorption at a wavelength or a range of wavelengths, including but not limited to, ultra-violet, near ultra-violet, visible, near-infrared, infrared, and/or infrared wavelengths. Examples of photo-induced absorption in the glass article include, for example, and without limitation, color-center formation, transient glass defect formation, and permanent glass defect formation.

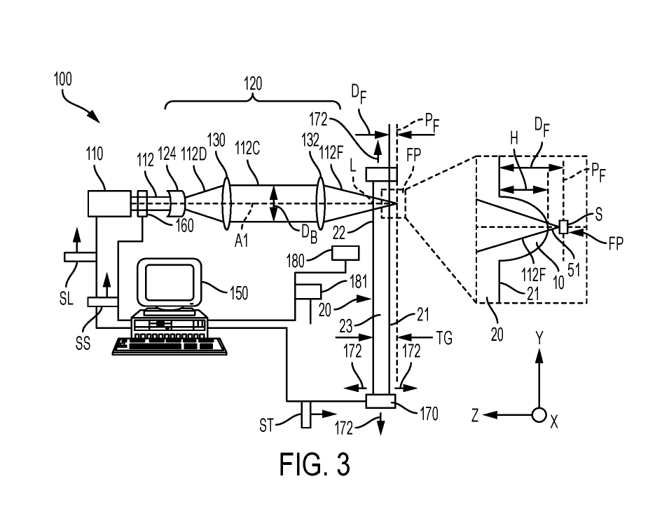

FIG. 3 is a schematic diagram of an example laser-based apparatus (“apparatus 100”) used to form dimpled glass bumps 10 in the glass article (e.g., the glass pane 20). Apparatus 100 may include a laser 110 arranged along an optical axis A1. Laser 110 emits a laser beam 112 having power P along the optical axis A1. In an example embodiment, laser 110 operates in the ultraviolet (UV) region of the electromagnetic spectrum. Laser irradiation dose is a function of laser beam 112 power P and an exposure time.

Apparatus 100 also includes a focusing optical system 120 that is arranged along optical axis A1 and defines a focal plane P_{F} that includes a focal point FP. In an example embodiment, the focusing optical system 120 includes, along optical axis A1 in order from laser 110: a combination of a defocusing lens 124 and a first focusing lens 130 (which in combination forms a beam expander), and a second focusing lens 132. In an alternative embodiment, focusing optical system 120 includes, along optical axis A1 in order from laser 110: a beam expander and a second focusing lens 132. Beam expander may be configured to increase or decrease the diameter of laser beam 112 by two times or four times to create collimated laser beam 112C with an adjusted diameter D_{B}.

In an example embodiment, defocusing lens 124 has a focal length fD=−5 cm, first focusing lens 130 has a focal length fC1=20 cm, and second focusing lens 132 has a focal length fC2=3 cm and a numerical aperture NAC2=0.3. In an example embodiment, defocusing lens 124 and first and second focusing lenses 130 and 132 are made of fused silica and include anti-reflection (AR) coatings. In embodiments, the first focusing lens 130 is spherical and the second focusing lens 132 is aspherical. In embodiments, the second focusing lens 132 has a numerical aperture NAC2=0.5. Alternate example embodiments of focusing optical system 120 include mirrors or combinations of mirrors and lens elements configured to produce focused laser beam 112F from laser beam 112.

Apparatus 100 also includes a controller 150, such as a laser controller, a microcontroller, computer, microcomputer or the like, electrically connected to the laser 110 and adapted to control the operation of the laser 110. In an example embodiment, a shutter 160 is provided in the path of laser beam 112 and is electrically connected to controller 150 so that the laser beam can be selectively blocked to turn the laser beam “ON” and “OFF” using a shutter control signal SS rather than turning laser 110 “ON” and “OFF” with a laser control signal SL.

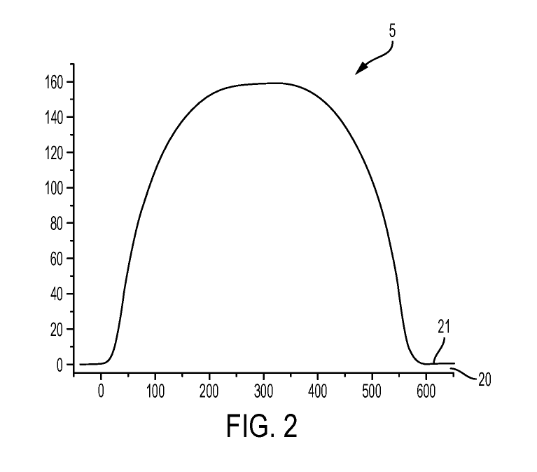

Prior to initiating the operation of apparatus 100, the glass article (e.g., the glass pane 20) is disposed relative to the apparatus. Specifically, the glass article is disposed along optical axis A1 so that a surface of the glass article is substantially perpendicular to the optical axis A1. In an example embodiment, glass pane 20, including the front surface 22 and the back surface 21, is disposed relative to optical axis A1 so that back surface 21 of the glass pane 20 is slightly axially displaced from focal plane PF in the direction towards laser 110 (i.e., in the +Z direction) by a distance DF. Distance DF may range from 0.1 millimeters to 3 millimeters, or from about 0.5 millimeter to about 1.5 millimeters. Distance DF was 1 mm when forming a precursor glass bump 5 and dimpled glass bump 10 in FIGS. 2 and 1, respectively. In yet another embodiment of forming the dimpled glass bump 10, numerical aperture NAC2=0.3. In another example embodiment, the glass pane 20 has a thickness TG in the range 0.5 millimeters ≤TG≤6 millimeters. Using these parameters, the dimpled glass bump 10 of the present disclosure is capable of being grown from the glass pane 20. Conventional methods of forming glass bumps have not produced a glass bump with a dimpled or concave top surface (along 1-10% of the top portion of its height) without the use of a top surface molding structure.

In an example method of operating apparatus 100, the laser 110 may be activated via control signal SL from the controller 150 to the generate laser beam 112. If the shutter 160 is used, then after laser 110 is activated, the shutter is activated and placed in the “ON” position via shutter control signal SS from controller 150 so that the shutter passes laser beam 112. The laser beam 112 is then received by focusing optical system 120, and defocusing lens 124 therein causes the laser beam to diverge to form a defocused laser beam 112D. Defocused laser beam 112D is then received by first focusing lens 130, which is arranged to form an expanded collimated laser beam 112C from the defocused laser beam. Collimated laser beam 112C is then received by the second focusing lens 132, which forms a focused laser beam 112F. Focused laser beam 112F passes through the glass pane 20 and forms a spot S along optical axis A1 at focal point FP, as mentioned above, is at a distance D_{F} from the back surface 21 of the glass pane 20 and thus resides outside of the body portion 23. The intersection between the converging laser beam 112F and glass pane 20 front surface 22 is referred to herein as a locality L.

A portion of focused laser beam 112F is absorbed as it passes through glass pane 20 (at locality L) due to the aforementioned photo-induced absorption in the glass pane. This serves to locally heat glass pane 20 at locality L. Methods of the present disclosure include irradiating the glass article surface with laser radiation for a time to locally heat and induce growth of a precursor glass bump 5 (FIG. 2) from the glass pane 20. The time of the initial irradiation may be from about 0.01 second to about 10 seconds. The amount of photo-induced absorption may be relatively low, e.g., about 3% to about 50%. The precursor glass bump 5 begins to form as a limited expansion zone is created within glass pane 20 body portion 23 in which a rapid temperature change induces an expansion of the glass. Since the expansion zone is constrained by unheated (and therefore unexpanded) regions of glass surrounding the expansion zone, the molten glass within the expansion zone is compelled to relieve internal stresses by expanding/flowing upward, thereby forming precursor glass bump 5. If the focused laser beam 112F has a circularly symmetric cross-sectional intensity distribution, such as a Gaussian distribution, then the local heating and the attendant glass expansion occurs over a circular region in body portion 23 of the glass pane 20, and the resulting precursor glass bump 5 may be substantially circularly symmetric. Laser irradiation may be paused or stopped any time after initiating irradiation at locality L.

In embodiments, the aforementioned irradiation process forms a precursor glass bump 5. FIG. 2 provides an example precursor glass bump 5, which may be a precursor to the dimpled glass bump 10 of FIG. 1. Precursor glass bump 5 in FIG. 2 was formed by a system as described above with about 1.45 seconds of 14 Watts of laser irradiation at a wavelength of 355 nm. Precursor glass bump 5 in FIG. 2 has a height of about 158 microns and a base diameter of about 585 microns. Precursor glass bump 5 in FIG. 2 has a semi-spherical shape. Of course, precursor glass bump 5 can have other shapes and is generally taller than dimpled glass bump 10. In embodiments, pausing the irradiation of the glass pane 20 for a period of time after forming the precursor glass bump 5 allows the precursor glass bump 5 to cool. That is, pausing irradiation on precursor glass bump 5 formed at a locality L allows its temperature to reduce below the softening point of the glass. In embodiments, irradiation may be paused for about 0.1 second to about 100 seconds or more, or even about 1 seconds to about 10 seconds.

Methods of the present disclosure include irradiating the precursor glass bump 5 formed at locality L again with laser radiation to form the dimpled glass bump 10 shown in FIG. 1. That is, a second irradiating step on the precursor glass bump 5 (formed by the first irradiating step) provides the geometry of the dimpled glass bump 10 disclosed herein. Specifically, a concavely rounded top portion 45 between convexly rounded top portions 44 is formed as described herein. That is, the top surface 42 of the dimpled glass bump 10 includes volume 50 (e.g., a dimple). The dimpled glass bump 10 shown in FIG. 1 was formed by irradiating the precursor glass bump 5 shown in FIG. 2 with about 0.65 seconds of 14 Watts of laser irradiation at a wavelength of 355 nm after pausing for 2 seconds between exposures. Of course, the time of the secondary irradiation may be the same as the initial radiation, or less time, or more. In embodiments, the second irradiating step has a time from about 0.05 second to about 1 second. The second irradiation step may cause the height of precursor glass bump 5 to decrease. In embodiments, the height H10 of the dimpled glass bump 10 may be from about 30% to about 90%, or from about 40% to about 70%, less than the precursor glass bump 5. The height of the precursor glass bump 5 in FIG. 2 decreases by about 80 microns, or by about 51%, while becoming the dimpled glass bump 10 of FIG. 1. The second irradiation step may cause the base diameter of the precursor glass bump 5 to increase. In embodiments, the dimpled glass bump 10 may have a diameter D1 from about 20% to about 60%, or from about 30% to about 50%, greater than the diameter of the precursor glass bump 5. The base diameter of the precursor glass bump 5 in FIG. 2 may increase by about 228 microns, or about 39%, while becoming the dimpled glass bump 10 of FIG. 1. In embodiments, the total glass volume of the dimpled glass bump 10 is ±5% of the total volume of precursor glass bump 5.

Methods of the present disclosure do not include a step of annealing the glass article including the precursor glass bump 5. That is, the precursor glass bump 5 is not annealed before the second irradiating step resulting in the dimpled glass bump 10. Annealing the glass article including the precursor glass bump 5 would prevent the the growth of the dimpled glass bump 10 as disclosed herein. Without being bound by theory, the volume 50 (or the dimple) of the dimpled glass bump 10 forms because of stress within the precursor glass bump 5 caused by the laser-irradiation growth process. However, annealing precursor glass bump 5 before the secondary irradiation process may alleviate the stress within the bump and result in a convexly rounded top surface without a concavely rounded top portion 45.

The methods of forming the dimpled glass bump 10 can be repeated at different locations (e.g., localities L) on the glass pane 20 to form a plurality (e.g., an array) of dimpled glass bumps 10 in the glass pane 20. In an example embodiment, apparatus 100 includes an X-Y-Z stage 170 electrically connected to controller 150 and configured to move glass pane 20 relative to focused laser beam 112F in the X, Y and Z directions, as indicated by large arrows 172. This allows for a plurality of dimpled glass bumps 10 to be formed by selectively translating stage 170 via a stage control signal ST from controller 150 and irradiating different locations in the glass pane 20. In another example embodiment, focusing optical system 120 is adapted for scanning so that focused laser beam 112F can be selectively directed to locations in glass pane 20 where the dimpled glass bumps 10 are to be formed.

As used herein, the singular forms “a,” “an,” and “the” include plural referents unless the context clearly dictates otherwise. Thus, for example, reference to a “metal” includes examples having two or more such “metals” unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It is also noted that recitations herein refer to a component of the present disclosure being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

It will be apparent to those skilled in the art that various modifications and variations can be made to the present disclosure without departing from the spirit and scope of the disclosure herein. Since modifications combinations, sub-combinations and variations of the disclosed embodiments incorporating the spirit and substance of the present disclosure may occur to persons skilled in the art, the present disclosure should be construed to include everything within the scope of the appended claims and their equivalents.

1. A glass article comprising a glass article surface and a dimpled glass bump extending from the glass article surface, the dimpled glass bump comprising:
a lower region comprising a diameter D1 defined by concavely rounded sides comprising a radius of curvature R1, wherein the concavely rounded sides join with the glass article surface and the lower region projects from the glass article surface; and
an inflection region connecting the lower region of the dimpled glass bump and an upper region of the dimpled glass bump; and
the upper region of the dimpled glass bump comprises a transition portion and a top surface, wherein:
the transition portion comprises a diameter D2 defined by convexly rounded sides comprising a radius of curvature R2;
the diameter D2 is less than the diameter Dl;
the top surface comprises a diameter D3 defined by a concavely rounded top portion disposed between convexly rounded top portions;
the convexly rounded top portions join with the convexly rounded sides converging from the transition portion;
the diameter D3 is less than the diameter D2; and
the convexly rounded top portions are spaced apart from the glass article surface, thereby defining a height H of the dimpled glass bump.

2. The glass article of claim 1 wherein the convexly rounded top portions have a radius of curvature R3 from about 300 microns to about 1600 microns.

3. The glass article of claim 1 wherein the concavely rounded top portion has a radius of curvature R4 from about 200 microns to about 2000 microns.

4. The glass article of claim 1 further comprising a volume adjacent the concavely rounded top portion and between the convexly rounded top portions.

5. The glass article of claim 4, further comprising a friction reduction material within the volume.

6. The glass article of claim 5 wherein the friction reduction material comprises tungsten disulfide, molybdenum disulfide, tungsten diselanide, molybdenum diselanide, or combinations thereof.

7. The glass article of claim 1 wherein the radius of curvature R1 of the concavely rounded sides of the lower region is from about 30 microns to about 150 microns.

8. The glass article of claim 1 wherein the diameter D1 of the lower region is from about 600 microns to about 900 microns.

9. The glass article of claim 1 wherein the radius of curvature R2 of the convexly rounded sides of the transition portion is from about 1000 microns to about 5000 microns over at least 5% of the height H.

10. The glass article of claim 1 wherein the diameter D2 of the transition portion decreases from the inflection region to the top surface by about 15% to about 65%.

11. The glass article of claim 1 wherein the diameter D2 of the transition portion is from about 300 microns to about 700 microns.

12. The glass article of claim 1 wherein the diameter D3 of the top surface is from about 200 microns to about 600 microns.

13. The glass article of claim 1 wherein the height H is from about 20 microns to about 200 microns.

14. The glass article of claim 1 wherein the lower region is from about 5% to about 25% of the height H.

15. The glass article of claim 1 wherein the upper region is from about 65% to about 95% of the height H.

16. The glass article of claim 1 wherein the top surface is from about 1% to about 10% of the height H.

17. A dimpled glass bump formed on a glass pane surface of a glass pane, the dimpled glass bump comprising:
a lower region comprising a diameter D1 defined by concavely rounded sides, wherein the lower region projects from the glass pane surface, wherein the concavely rounded sides have a radius of curvature R1 and join with the glass pane surface;
an inflection region connecting the lower region of the dimpled glass bump and an upper region of the dimpled glass bump;
the upper region comprising a transition portion and a top surface, wherein:
the transition portion comprises a diameter D2 defined by convexly rounded sides, wherein the convexly rounded sides have a radius of curvature R2 and the diameter D2 is less than diameter D1; and
the top surface comprise a diameter D3 defined by a concavely rounded top portion positioned between convexly rounded top portions, the convexly rounded top portions joining with the convexly rounded sides, wherein the diameter D3 is less than the diameter D2 and the convexly rounded top portions are spaced apart from the glass article surface thereby defining a height H of the dimpled glass bump.

18. The dimpled glass bump of claim 17 wherein the convexly rounded top portions have a radius of curvature R3 of from about 300 microns to about 1600 microns.

19. The dimpled glass bump of claim 17 wherein the concavely rounded top portion has a radius of curvature R4 from about 200 microns to about 2000 microns.

20. The dimpled glass bump of claim 17 further comprising a volume contiguous the concavely rounded top portion and between the convexly rounded top portions.

21. The dimpled glass bump of claim 17 further comprising a friction reduction material disposed within the volume.

22. The dimpled glass bump of claim 21 wherein the friction reduction material comprises tungsten disulfide, molybdenum disulfide, tungsten diselanide, molybdenum diselanide, or combinations thereof.

23. The dimpled glass bump of claim 17 as a spacer in a vacuum insulated glass window.

24. A method of making the article of claim 1, wherein the article is a glass pane, the method comprising:
irradiating the glass pane surface with laser radiation to locally heat and induce growth of a precursor glass bump from the glass pane,
pausing irradiation of the glass pane for a time, and
irradiating the precursor glass bump with laser radiation to form the dimpled glass bump.

25. The method of claim 24 wherein the time is from about 0.1 second to about 100 seconds.

26. The method of claim 24 further comprising contacting the top surface of the glass bump with a structure to form the concavely rounded top portion.

27. The method of claim 24 wherein focusing for the laser radiation is the same for growth of a precursor glass bump and for forming the dimpled glass bump.

28. The method of claim 24 wherein focusing for the laser radiation for forming the dimpled glass bump is different than focusing for the laser radiation for growth of a precursor glass bump by about 0.01 mm to about 1 mm.
